(19) United States
(12) Patent Application Publication
(10) Pub. No.: US 2002/0069164 A1
(43) Pub. Date: Jun. 6, 2002

(54) Method and system for saving and recalling bill of material information

(76) Inventors: Franciscus Reza Paul Adam, Bristol, CT (US); Michael A. Motley, Simsbury, CT (US); Ramanathan Valliyappan, Plainville, CT (US); Darrin Kenneth Bock, Sturbridge, MA (US)

Correspondence Address: John S. Beulick, Armstrong Teasdale LLP, One Metropolitan Square, Suite 2600, St. Louis, MO, 63102, US

(21) Appl. No.: 09/729,539

(22) Filed: Dec. 4, 2000

(51) Int. Cl. G06F 17/60

(52) U.S. Cl. 705/40; 705/34

(57) ABSTRACT

A network-based method for saving and recalling bill of material information includes receiving bill of material specification information from a user and using a server to compare the received specification information with pre-stored information. The method also includes selecting at least one bill of material that matches the received specification information and displaying to the user information related to the bill of material, and providing the user the option of ordering the product on the bill of material.

### BACKGROUND OF THE INVENTION

This invention relates generally to computer network-based systems and more particularly to a network-based method and system for saving user information Electronic commerce (e-commerce) sites on the Internet allow users to purchase products online and to generate a bill of material for products that have been ordered. Currently, users of e-commerce sites do not have the capability to save and recall Bill of Material information as each Bill of Material is typically lost at the end of each user session. This is a significant drawback in many situations. Large and complex orders can be difficult to enter at one time, necessitating multiple orders often at different times. Some users at the time they access the e-commerce website may not have all of the requisite information completely defined. One example would be users who are accessing an e-commerce site to obtain information for budgetary purposes that they may subsequently convert to an order if their budgetary submission is approved. Those who are re-ordering a product are another example of users who have to reenter the same information they have entered previously.

Users therefore often have to reenter information entered into the system, which inconveniences users and increases the chance of errors. It would be desirable for users of an e-commerce web site to be able to save and retrieve a previously generated bill of material and to edit and re-submit the saved bill of material for fulfillment.

### BRIEF SUMMARY OF THE INVENTION

In an exemplary embodiment, a system for saving user information allows users to use the Internet to select a previously submitted bill of material. The network-based method for selecting a bill of material includes receiving bill of material specification information from a user and comparing the received bill of material specification information with pre-stored bill of material information. If at least one bill of material matches the received user criteria for the bill of material, the pre-stored bill of material information is downloaded for communication to the user. The bill of material information may include, for example, a quote name, a bid date, a bid type, a reference number, or the name of a user.

### BRIEF DESCRIPTION OF THE DRAWINGS

FIG. 1 is a block diagram of a system in accordance with one embodiment of the present invention;

FIG. 2 is an expanded version block diagram of an exemplary embodiment of a server architecture of an alternative system;

FIG. 3 is a flow diagram of a network-based method for saving and recalling user information;

FIG. 4 is an exemplary embodiment of a product selection page;

FIG. 5 is an exemplary embodiment of an Add to Bill of Material page;

FIG. 6 is an exemplary embodiment of a Quotation Information page;

FIG. 7 is an exemplary embodiment of a Save Option page;

FIG. 8 is an exemplary embodiment of a Quotation Manager Select Quotation page;

FIG. 9 is an exemplary embodiment of a Quotes Search page;

FIG. 10 is an exemplary embodiment of a Quotation Search Results page;

FIG. 11 is an exemplary embodiment of a How to Order page;

FIG. 12 is an exemplary embodiment of an Add Products page;

FIG. 13 is an exemplary embodiment of a Quotation Manager page;

FIG. 14 is an exemplary embodiment of a Printing Options page;

FIG. 15 is an exemplary embodiment of a recalled bill of material page; and

FIG. 16 is an exemplary embodiment of an updated version of a recalled bill of material page.

### DETAILED DESCRIPTION OF THE INVENTION

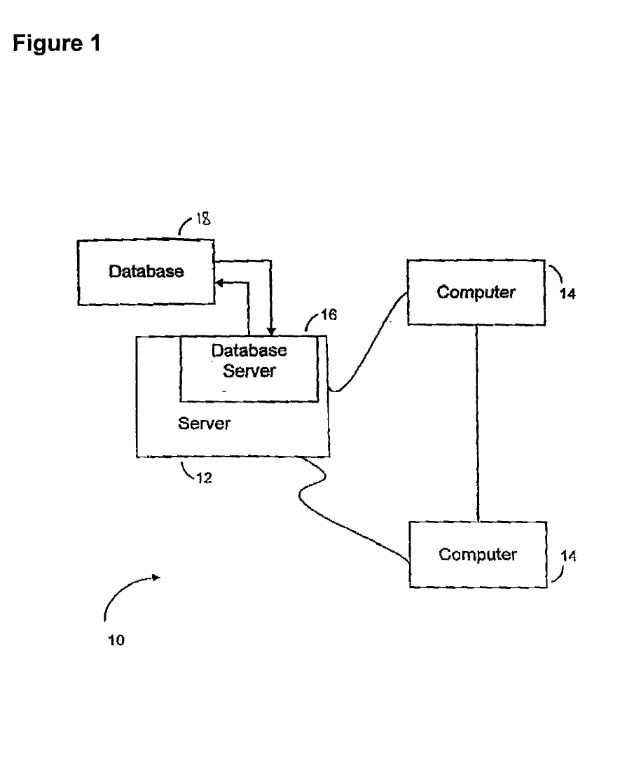

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a network-based phone or other network-based connectable equipment. Server 12 includes a database server 16 connected to a centralized database 18 containing bill of material information. In one embodiment, centralized database 18 is stored on database server 16 and can be accessed by potential users at one of user devices 14 by logging onto server sub-system 12 through one of user devices 14. In an alternative embodiment centralized database 18 is stored remotely from server 12.

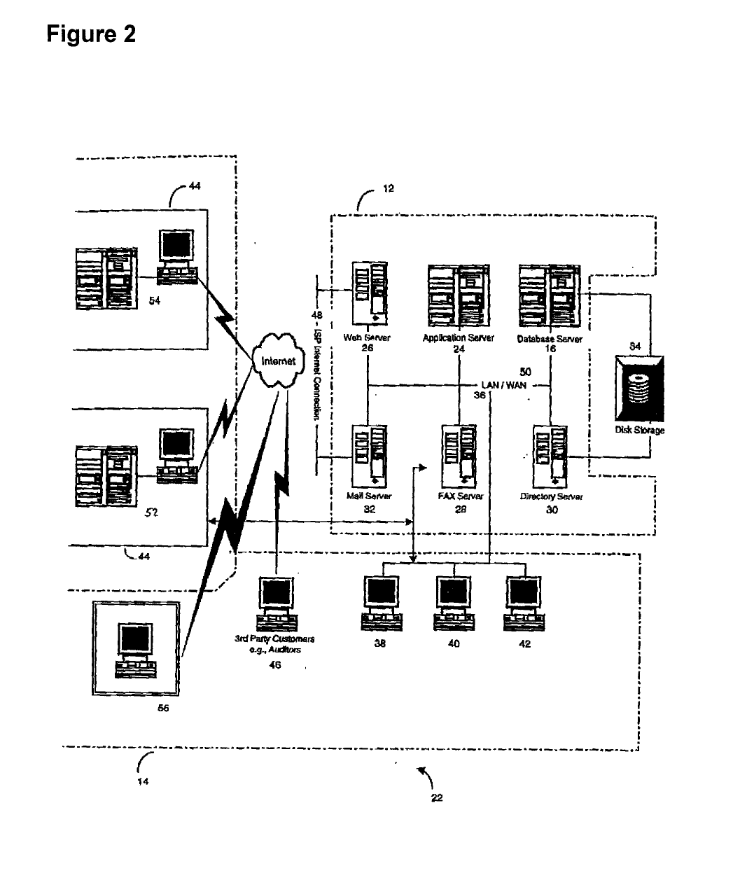

FIG. 2 is an expanded version block diagram of an exemplary embodiment of a server architecture of a system 22. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a workstation 52 can access server sub-system 12. One of user devices 14 includes a workstation 54 located at a remote location. Workstations 52 and 54 are personal computers having a web browser. Also, workstations 52 and 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

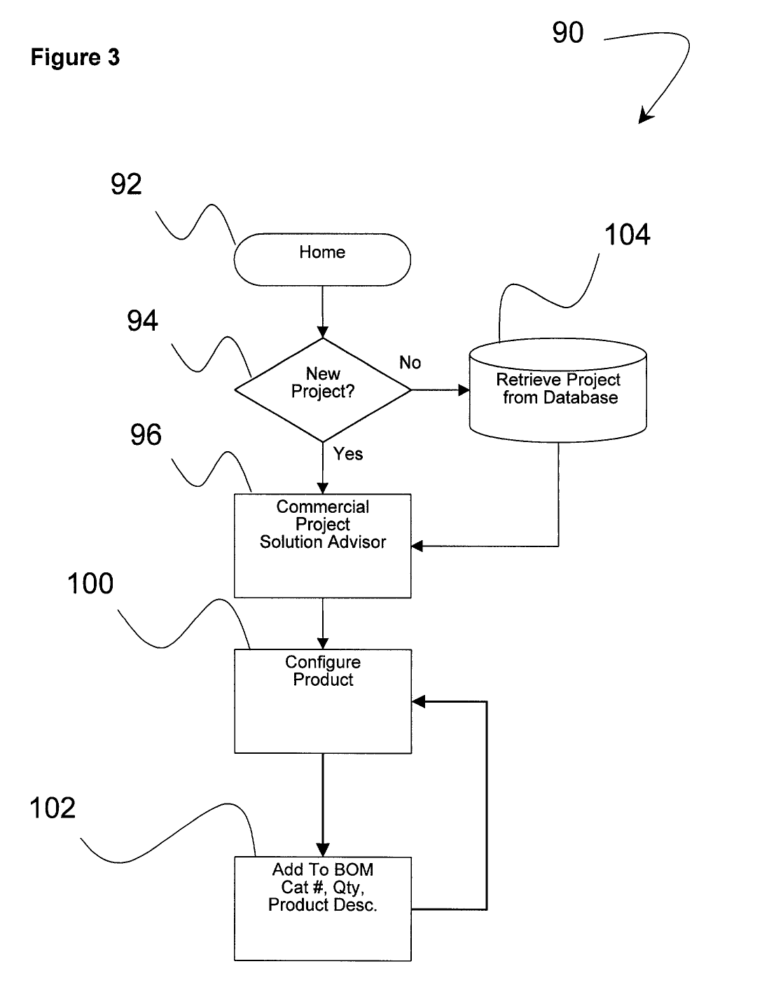

FIG. 3 is a flow diagram 90 for a network-based method for saving and recalling user information. System 10 (shown in FIG. 1) displays a Home page 92. In one embodiment, the user inputs the information into a device (such as device 14 shown in FIG. 1) that transmits the information to a server (such as server 12 shown in FIG. 1). The user information is received from the user via a graphical user interface as will be described in greater detail below.

Home page 92 allows selection 94 of a new project. On selection 94 of a new project server 12 displays a commercial project solution adviser page 96 that guides the user to configure a product correctly to meet the user's specifications. Once the product has been configured in a configured product page 100, the system then adds 102 the product to a bill of material, including in one embodiment a catalog number, quantity, and product description.

Alternatively, if the user indicates that the project is not new, server 12 then receives identification information from the user and retrieves 104 a selected project from a database resident on server 12. In one embodiment, the pre-stored information is stored in a database that resides on server 12. In an alternative embodiment, the pre-stored information is stored in a database remote from server 12. The pre-stored information includes various types of bill of material-related information. Server 12 compares the user provided information to the pre-stored information to determine if any pre-stored bill of material-related information contained in the database satisfy the product specifications submitted by the user.

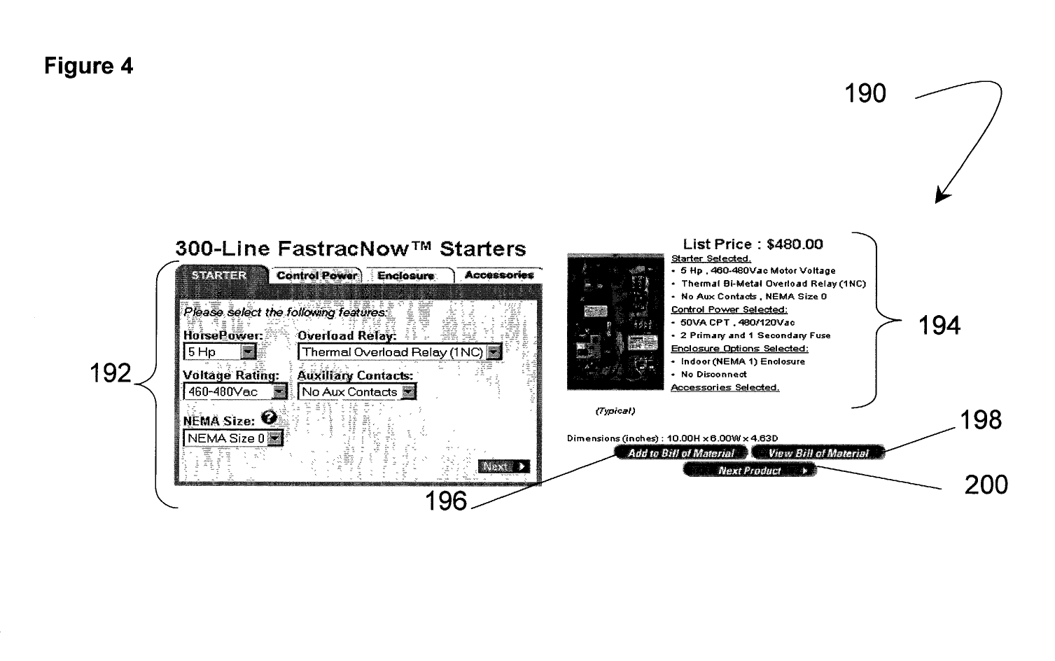

FIG. 4 shows an exemplary embodiment of a product selection page, as depicted in screen shot 190, which includes a product selection area 192 that includes a plurality of pull down menus that allow selection of a product. Screen shot 190 also includes a recommendation area 194 to display a recommended product that conforms to the users specifications. Screen shot 190 also includes an Add to Bill of Material button 196, a View Bill of Material button 198, and a Next Product button 200.

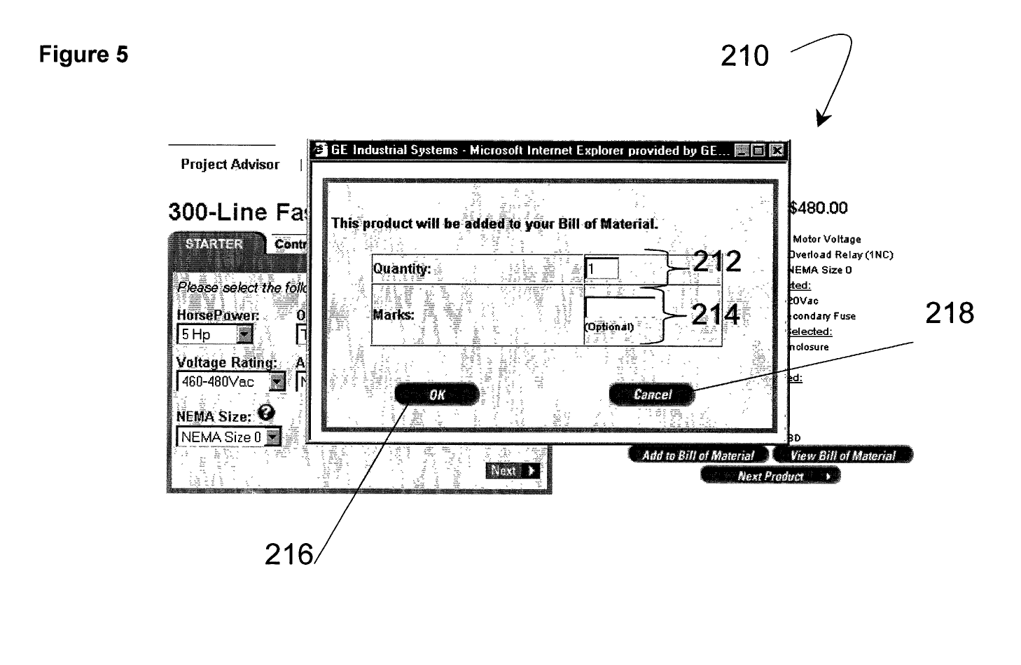

FIG. 5 shows an exemplary embodiment of an Add to Bill of Material page, as depicted in screen shot 210, which server 12 displays when Add to Bill of Material button 196 in FIG. 4 is selected. Screen shot 210 includes a Quantity selection area 212, a Marks selection area 214, an OK button 216, and a Cancel button 218.

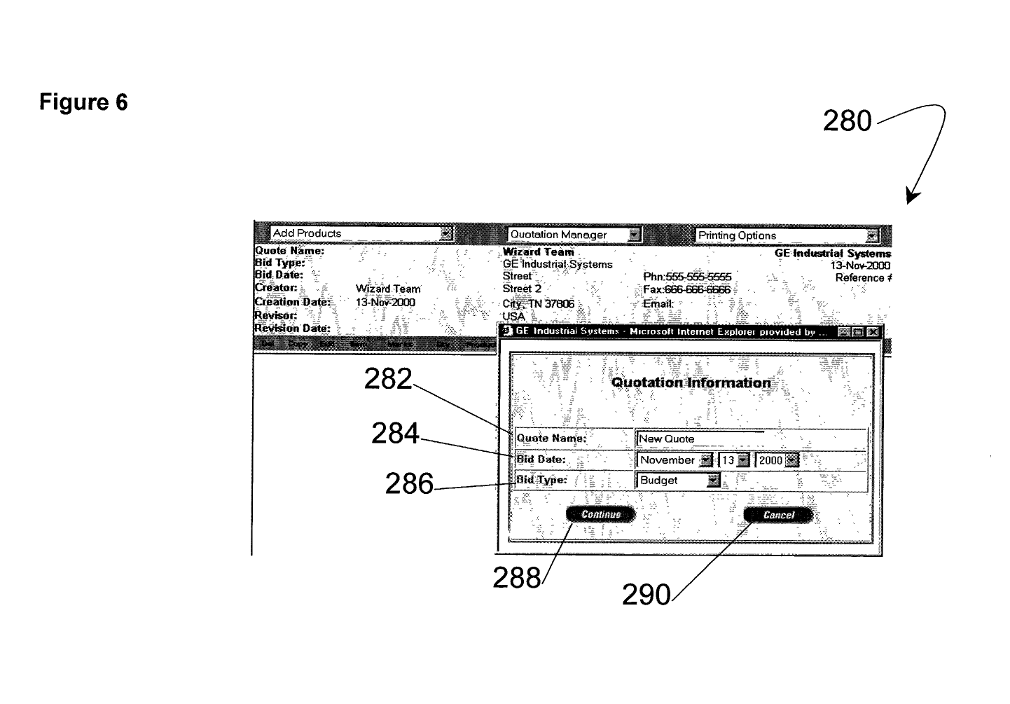

FIG. 6 shows an exemplary embodiment of a Quotation Information page, as depicted in screen shot 280. Screen shot 280 includes a Quote Name text box 282, a set of Bid Date pull down menus 284, a Bid Type pull down menu 286, a Continue button 288, and a Cancel button 290.

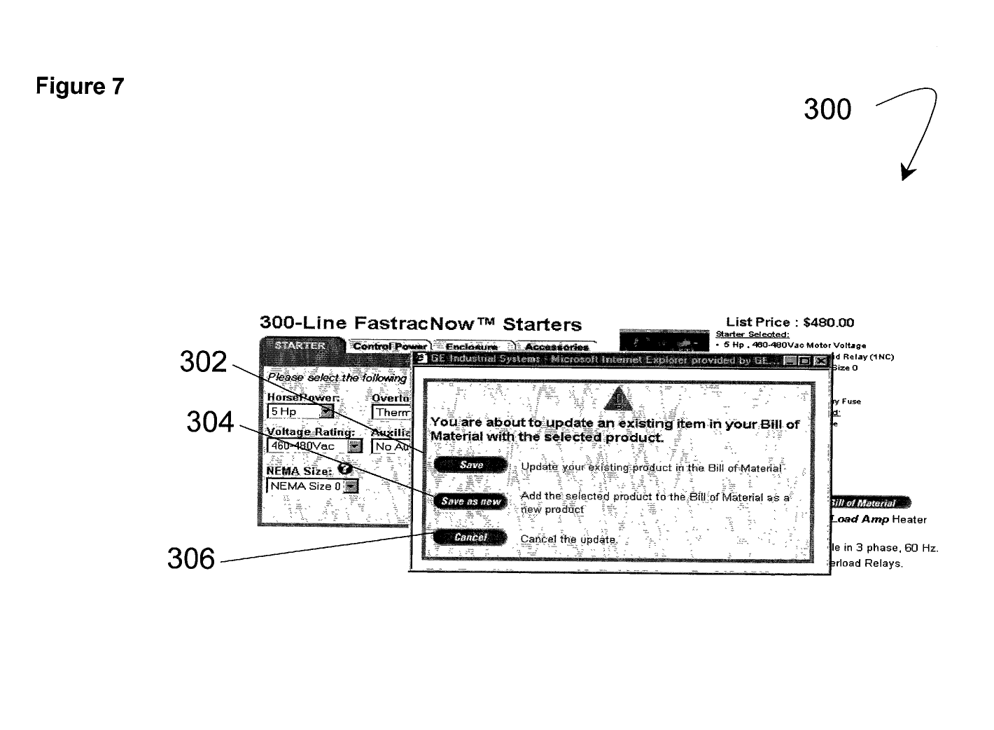

FIG. 7 shows an exemplary embodiment of a Save Option page, as depicted in screen shot 300. Screen shot 300 includes a Save button 302 that updates the existing product in the bill of material, a Save as New button 304 that adds the selected product to the bill of material as a new product, and a Cancel button 306.

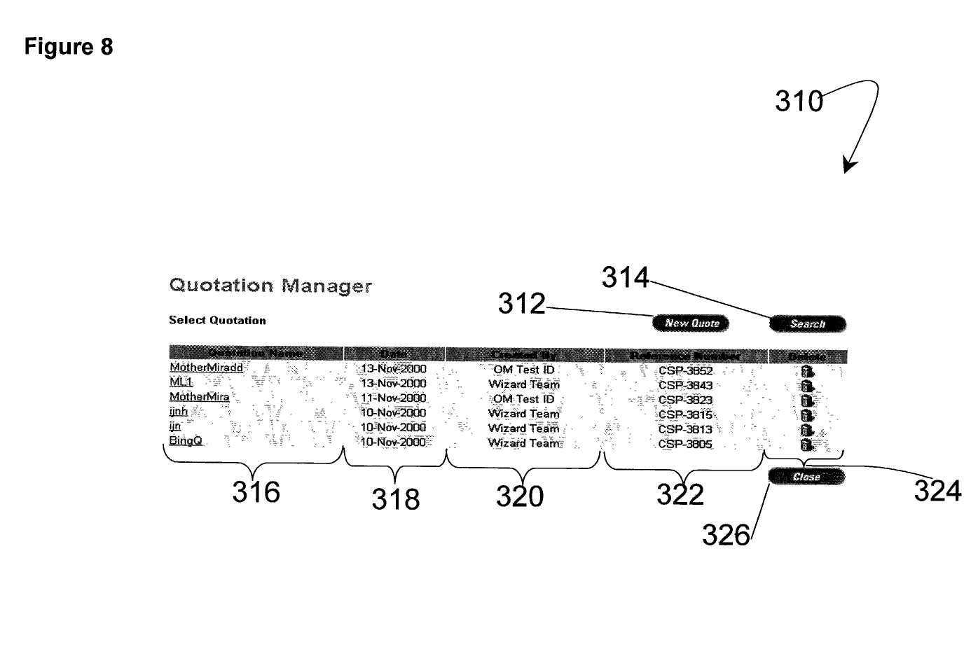

FIG. 8 shows an exemplary embodiment of a Quotation Manager Select Quotation page, as depicted in screen shot 310, which includes a New Quote button 312 and a Search button 314. Screen shot 310 also includes a Quotation Name display area 316, a Date display area 318, a Created By display area 320, a Reference Number display area 322, and a Delete link area 324. Screen shot 310 further includes a Close button 326.

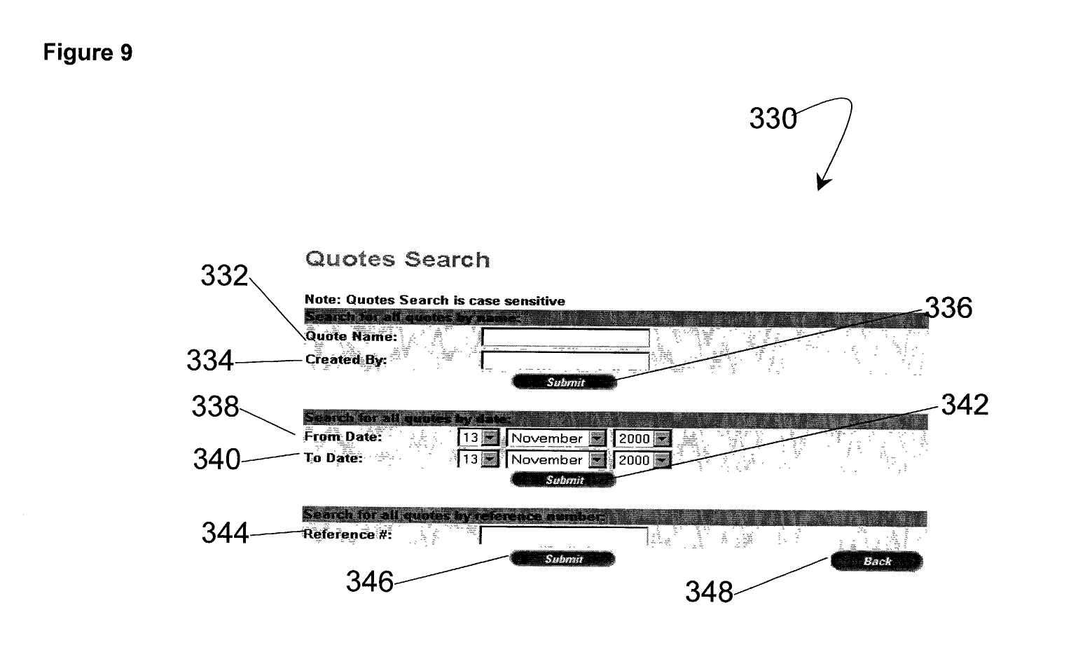

FIG. 9 shows an exemplary embodiment of a Quotes Search page, as depicted in screen shot 330. Screen shot 330 includes a Quote Name text box 332 for specifying a quote name, a Created By text box 334 for specifying the identity of the person who created the quote, and a Submit button 336. Screen shot 330 also includes a set of From Date pull down menus 338 for specifying a date, a set of To Date pull down menus 340 for specifying a date, and a Submit button 342. Screen shot 330 further includes a Reference # text box 344, for specifying a reference number, a Submit button 346, and a Back button 348.

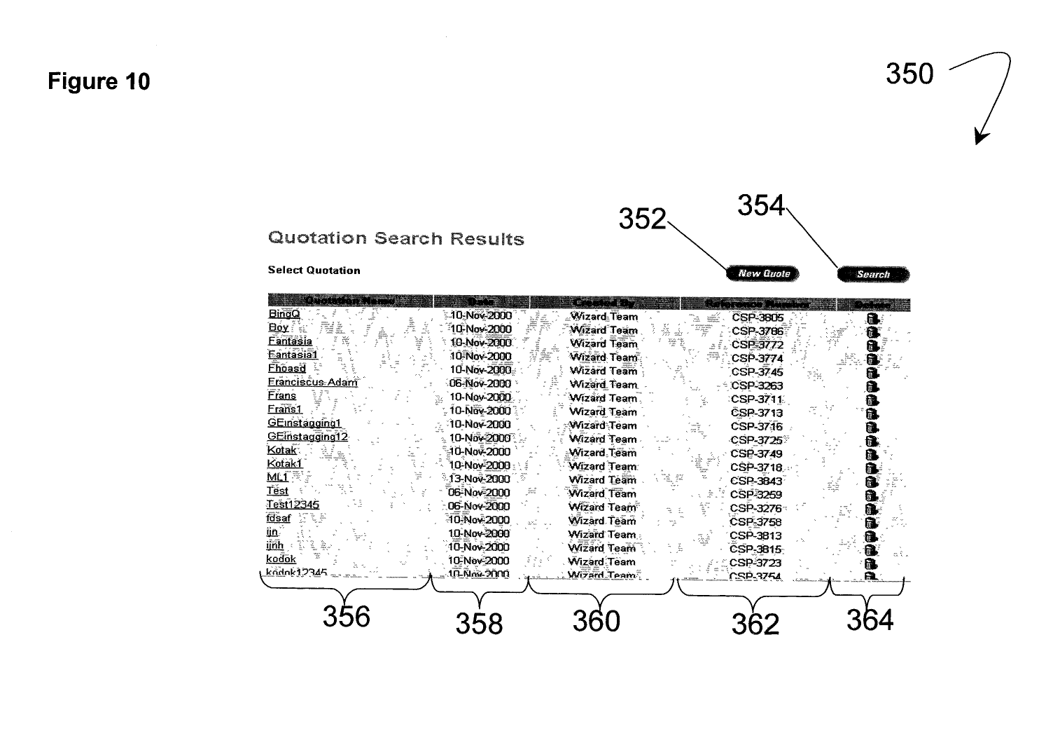

FIG. 10 shows an exemplary embodiment of a Quotation Search Results page, as depicted in screen shot 350, which includes a New Quote button 352, a Search button 354, a Quotation Name display area 356, a Date display area 358, a Created by display area 360, a Reference Number display area 362, and a set of Delete links 364.

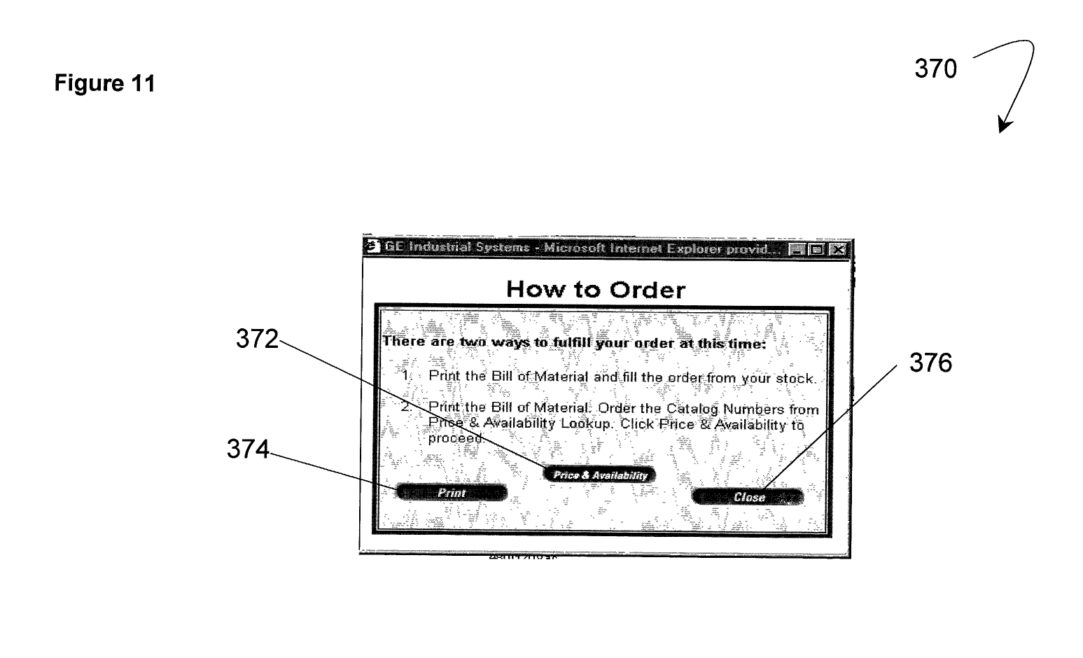

FIG. 11 shows an exemplary embodiment of a How to Order page, as depicted in screen shot 370, which includes a Price and Availability button 372, a Print button 374, and a Close button 376.

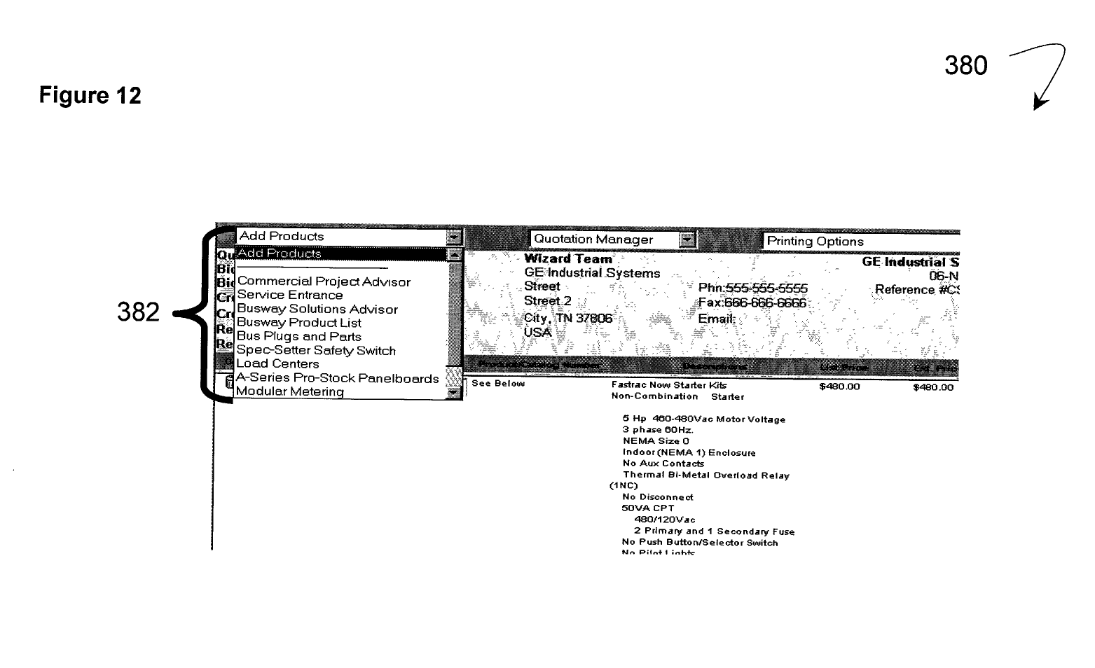

FIG. 12 shows an exemplary embodiment of a Add Products page, as depicted in screen shot 380, which includes an Add Products pull down menu 382 that includes entries for Commercial Project Advisor, Service Entrance, Busway Solutions Advisor, Bus Plugs and Parts, Spec-Setter Safety Switch, Load Centers, A-Series Pro-Stock Panelboards option, and Modular Metering options.

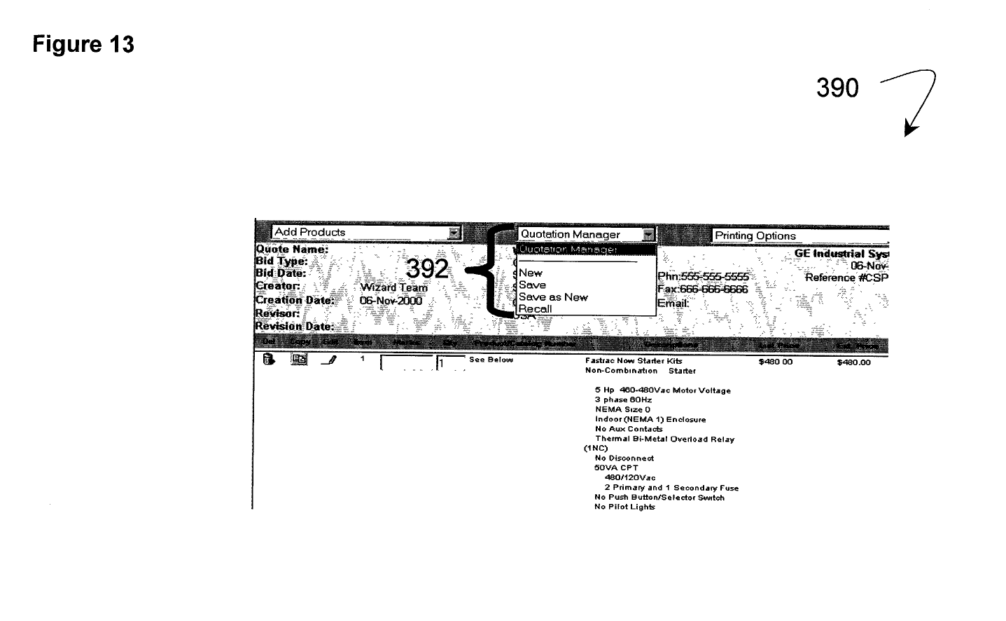

FIG. 13 shows an exemplary embodiment of a Quotation Manager page, as depicted in screen shot 390, which includes a Quotation Manager pull down menu 392 that includes entries for New, Save, Save as New, and Recall options. Selection of the Save as New option causes system 10 (shown in FIG. 1) to display the Quotation Information page (shown in FIG. 6). Selection of the Recall option causes system 10 to display the Quotation Manager Select Quotation page (shown in FIG. 8).

Screen shot 390 also includes a set of Delete, Copy, and Edit buttons 394. On selection of the Edit button the system brings the user back to the product selection page (shown in FIG. 4), preconfigured according to the product that the user wants to edit. After a change in the product configuration, selection of the “Add to Bill of Material” button a second time takes the user to the Save Option page (shown in FIG. 7) instead of the “Add to Bill of Material Page (shown in FIG. 5). At the Save Option page the user can select the save options (update, save as new, or cancel the update.) The Copy button allows the user to copy the same product with the same configuration to the bottom of the bill of material, while the Delete button allows the user to delete a product from the bill of material.

Screen shot 390 also has a set of Clear, Back, and How to Order buttons 396. Selection of the Clear button clears all products from the bill of material. Selection of the Back button takes the user back to the product selection page (shown in FIG. 4) and closes the opened bill of material, while selection of the How to Order button causes system 10 (shown in FIG. 1) to display the How to Order page (shown in FIG. 11).

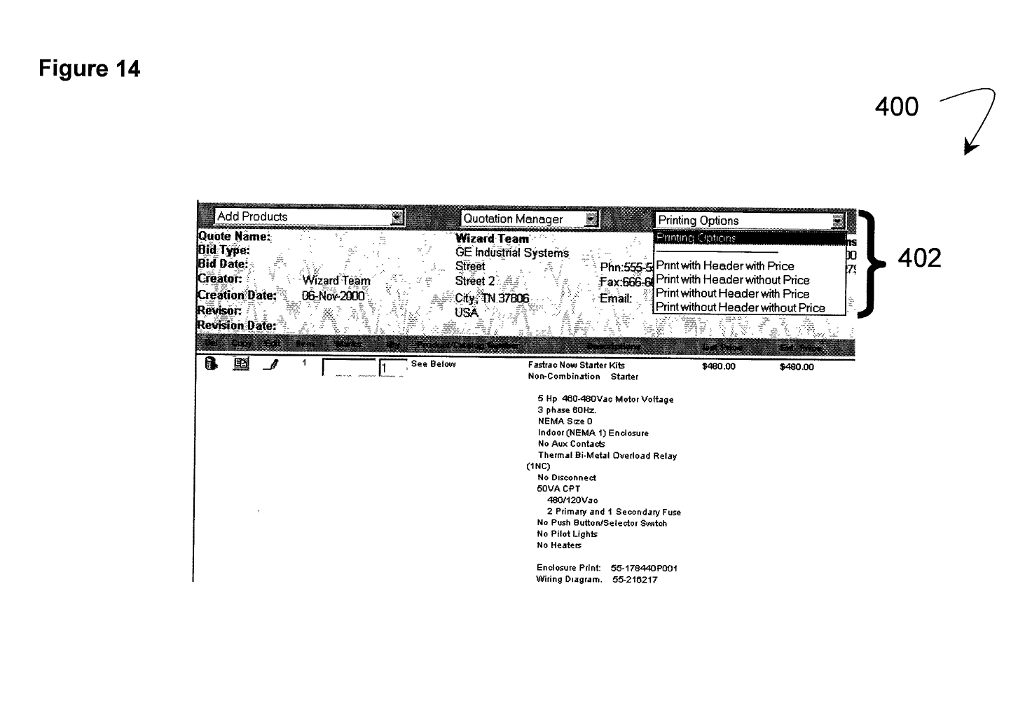

FIG. 14 shows an exemplary embodiment of a Printing Options page, as depicted in screen shot 400, which includes a Printing Options pull down menu 402 that includes entries for Print with Header with Price, Print with Header without Price, Print without Header with Price, and Print without Header without Price.

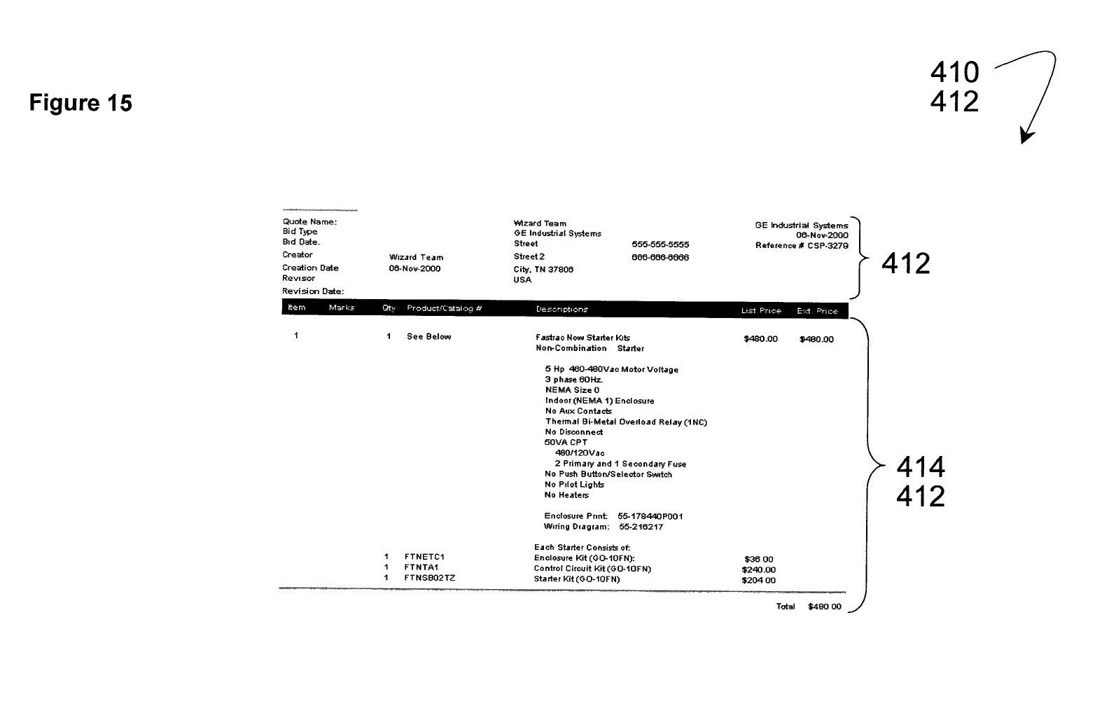

FIG. 15 shows an exemplary embodiment of a recalled bill of material page, as depicted in screen shot 410, which includes a bill of material information area 412 that in turn includes a reviser name, a revision date, a revision number, a project name, a purchase order number, a creation date and a reference number. In an alternative embodiment, screen shot 410 includes a customer purchase order number. Screen shot 410 also includes a product order information area 414 that includes information about a product being ordered.

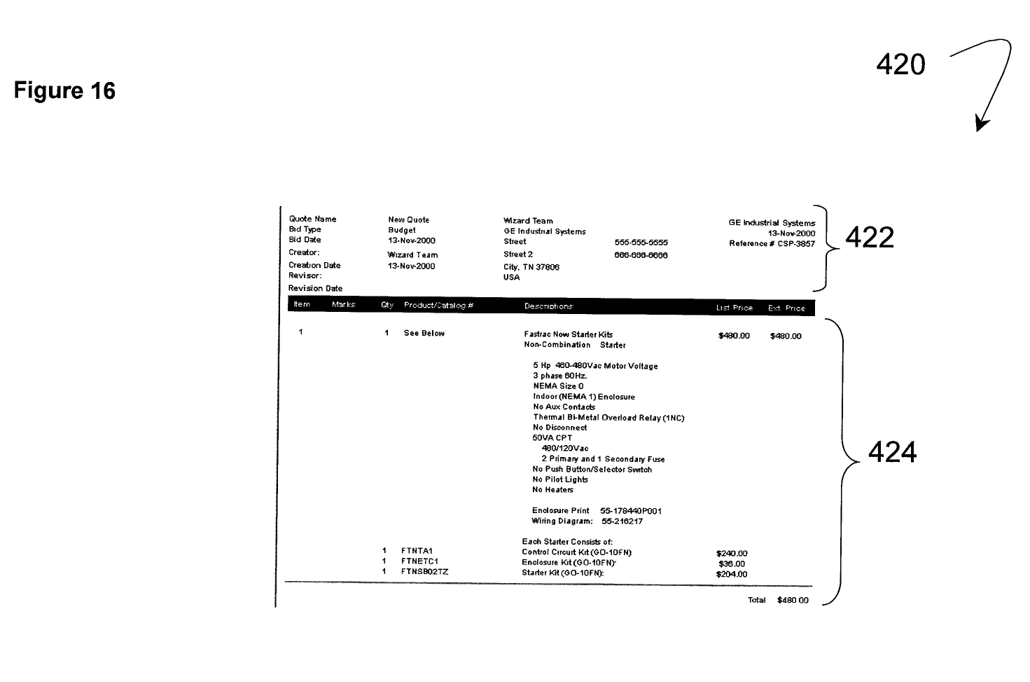

FIG. 16 shows an exemplary embodiment of an updated version of a recalled bill of material page, as depicted in screen shot 420, which includes a bill of material information area 422 that in turn includes an updated reviser name, revision date, revision number, project name, purchase order number, creation date and reference number. In an alternative embodiment, screen shot 420 also includes an updated customer purchase order number. Screen shot 420 also includes a product order information area 424 that includes information about a product being ordered.

While the invention has been described in terms of various specific embodiments, those skilled in the art will recognize that the invention can be practiced with modification within the spirit and scope of the claims.

What is claimed is:

1. A method for saving and recalling bill of material information using a network-based system including a server and at least one device connected to the server via a network, said method comprising the steps of:
receiving bill of material information from a user via the device;
comparing the received bill of material information with pre-stored bill of material information;
selecting at least one bill of material that matches the received information; and
displaying the pre-stored information related to the received bill of material information.

2. A method according to claim 1 wherein said step of receiving bill of material information from a user further comprises the step of receiving an identification for the bill of material.

3. A method according to claim 2 wherein said step of receiving bill of material information from a user further comprises the step of receiving at least one of an identifying number, a name, and a date.

4. A method according to claim 3 wherein said step of receiving bill of material information from a user further comprises the step of receiving at least one of a customer number, a creator name, a creation date, a reviser name, a revision date, a revision number, a project name, a bid date, a bid type, a purchase order number, and a customer purchase order number.

5. A method according to claim 3 wherein said step of receiving bill of material information from a user further comprises the step of receiving a customer number.

6. A method according to claim 3 wherein said step of receiving bill of material information from a user further comprises the step of receiving a creator name.

7. A method according to claim 3 wherein said step of receiving bill of material information from a user further comprises the step of receiving a creation date.

8. A method according to claim 3 wherein said step of receiving bill of material information from a user further comprises the step of receiving a reviser name.

9. A method according to claim 3 wherein said step of receiving bill of material information from a user further comprises the step of receiving a revision date.

10. A method according to claim 3 wherein said step of receiving bill of material information from a user further comprises the step of receiving a revision number.

11. A method according to claim 3 wherein said step of receiving bill of material information from a user further comprises the step of receiving a project name.

12. A method according to claim 3 wherein said step of receiving bill of material information from a user further comprises the step of receiving a bid date.

13. A method according to claim 3 wherein said step of receiving bill of material information from a user further comprises the step of receiving a purchase order number.

14. A method according to claim 3 wherein said step of receiving bill of material information from a user further comprises the step of receiving a customer purchase order number.

15. A method according to claim 1 further comprising the step of allowing the user to submit the pre-stored information as an order.

16. A method according to claim 1 further comprising the step of allowing the user to modify the pre-stored information.

17. A method according to claim 16 further comprising the step of allowing the user to submit the modified pre-stored information as an order.

18. A method according to claim 1 wherein said step of displaying information related to the bill of material comprises the step of displaying a catalog number and a list price for a product.

19. A method according to claim 1 wherein the bill of material information is received from the user via a graphical user interface.

20. A method according to claim 1 further comprising the step of validating configuration compatibility based on the received product specification information to determine whether a resulting product having the received product specifications is capable of meeting parameters of the product.

21. A method according to claim 23 further comprising the step of guiding the user, if the resulting product does not meet the parameters of the product, to a correct product configuration.

22. A method according to claim 20 further comprising the step of guiding the user to a compatible product.

23. A system for saving and recalling bill of material information, said system comprising:
a device; and
a server connected to said device and configured to receive bill of material information from a user via said device, said server further configured to:
compare the received bill of material information with pre-stored bill of material information;
select at least one bill of material from the pre-stored bill of material information based on identification criteria entered by the user; and
display information related to a product listed the bill of material selected based on the identification criteria.

24. A system according to claim 23 wherein said server is further configured to download to the user the information related to the bill of material.

25. A system according to claim 23 wherein said server is further configured to receive at least one of a customer number, a creator name, a creation date, a reviser name, a revision date, a revision number, a project name, a bid date, a bid type, a purchase order number, and a customer purchase order number.

26. A system according to claim 23 wherein said server is further configured to display the accessories selected for a product.

27. A system according to claim 23 wherein said server is further configured to receive an identification for a product.

28. A system according to claim 23 wherein said server is further configured to display the features selected for the product.

29. A system according to claim 23 wherein said server is further configured to display the accessories selected for the product.

30. A system according to claim 23 wherein said server is further configured to display a catalog number and a list price for the product.

31. A system according to claim 23 wherein said server is further configured to generate a quotation for the product.

32. A system according to claim 23 wherein said server is further configured to receive the bill of material information from the user via a graphical user interface.

33. A system according to claim 23 wherein said server is further configured to accept a purchase order for the product after the purchase order has been authenticated against pre-determined criteria.

34. A system according to claim 23 wherein said device is configured to be a server for a network of customer devices.

35. A system according to claim 23 wherein said server and said device are connected via a network.

36. A system according to claim 35 wherein said network is one of a wide area network, a local area network and the Internet.
